(19) United States
(12) Patent Application Publication
(10) Pub. No.: US 2023/0003930 A1
(43) Pub. Date: Jan. 5, 2023

(54) Magnetically-Assembled Light-Guide Panels

(71) Applicant: Elemental LED, Inc., Reno, NV (US)

(72) Inventor: Tupufia Leleua, Sparks, NV (US)

(21) Appl. No.: 17/856,392

(22) Filed: Jul. 1, 2022

Related U.S. Application Data
(60) Provisional application No. 63/218,109, filed on Jul. 2, 2021.

(51) Int. Cl. F21V 8/00

(52) U.S. Cl. CPC G02B 6/009; G02B 6/0078; G02B 6/0068; G02B 6/0088

(57) ABSTRACT

A light-emitting panel is disclosed. The light-emitting panel may be a light-guide panel (LGP) that includes a light guide, a light source arranged to emit light into the light guide, and a frame arrayed around the light guide and light source. The frame has one or more magnets associated with it, typically arrayed along at least one portion, which may be an edge. The magnets provide both mechanical and electrical connection points, such that a second LGP of the same type brought adjacent to the first LGP will be both mechanically and electrically connected to the first LGP.

### CROSS-REFERENCE TO RELATED APPLICATIONS

This application claims priority to, and the benefit of, U.S. Provisional Patent Application No. 63/218,109, filed Jul. 2, 2021, the contents of which are incorporated by reference herein in their entirety.

### TECHNICAL FIELD

The invention relates to light-guide panels.

### BACKGROUND

Light guide panels (LGPs) are flat-panel luminaires that are used to deliver well-diffused light over an area. They are typically used either to provide primary illumination for a room or area, or to backlight signs and displays.

LGPs are a type of light guide, a cousin of fiber optics—in an LGP, light is emitted into the edge of a panel. The panel is usually made of a transparent plastic like polymethyl methacrylate (PMMA) or polycarbonate that has a higher refractive index than air. By total internal reflection, the LGP contains much of the light, directs it, and diffuses it. In most modern LGPs, small surface defects are introduced into one surface of the LGP in order to reduce total internal reflection and release well-diffused light over the entire visible surface of the LGP.

Basic light guide technology has been available for many decades. For example, U.S. Pat. No. 2,443,561, issued in the late 1940s, describes a crib light that uses a light guide panel—in this case, an incandescent lamp emits light into the edge of a plastic panel. which is bent in a U-shape and hung over the sidewall of a crib such that the occupant of the crib is protected from the electrical elements and lamp. While innovative, products like this relied on bulky, hot incandescent lamps as light sources.

In recent decades, lighting based on light emitting diodes (LEDs) has become dominant in both residential and commercial settings. The rise of LED lighting has brought with it a resurgence in light guide technology and a number of sophisticated, LED-based LGPs. In contrast to its incandescent and fluorescent forebears, LED lighting is smaller, lighter, and generates less heat—particularly suitable for LGP applications, in which the objective is to emit light directly into the thin edge of a plastic or glass panel.

In a modern LGP, a sheet of light-guide material, such as PMMA or polycarbonate, is surrounded by a frame. At least one side of the frame contains a strip of linear lighting—a flexible or rigid printed circuit board (PCB) that contains LED light engines spaced at a regular pitch or spacing. The strip of linear lighting is oriented so that the LED light engines emit light into the side edge of the sheet of light guide material. Many LGPs have linear lighting along two sides, for more even light, and some may have strips of linear lighting along all four sides. The sheet of light-guide material is backed by a reflective layer, which may be a white sheet or a metallic/reflector sheet. In many cases, the front of the sheet of light guide material has an etched-in or burned-in pattern that helps to release light uniformly from the front of the panel. The pattern may be produced by, e.g., shallowly laser-etching the light-guide material.

Each modern LGP typically has a power cable that penetrates the frame to connect to the linear lighting. Most LGPs operate at low voltage using direct current (DC) power. While the definition of “low voltage” varies according to the source one consults, for purposes of this description, voltages under 50V will be considered to be low voltage. The use of low voltage carries with it fewer safety risks.

### BRIEF SUMMARY

One aspect of the invention relates to a light-emitting panel. The light-emitting panel may be a light-guide panel (LGP) that includes a light guide, a light source arranged to emit light into the light guide, and a frame arrayed around the light guide and light source. The frame has one or more magnets associated with it, typically arrayed along at least one edge. The magnets provide both mechanical and electrical connection points, such that a second LGP of the same type brought adjacent to the first LGP will be both mechanically and electrically connected to the first LGP, such that the first and second LGPs can share power.

Other aspects, features, and advantages of the invention will be set forth in the following description.

### BRIEF DESCRIPTION OF THE DRAWING FIGURES

The invention will be described with respect to the following drawing figures, in which like numerals represent like features throughout the description, and in which:

FIG. 1 is a plan view of a light-guide panel (LGP) according to one embodiment of the invention, illustrating the reverse (i.e., non-emitting) side of the LGP;

FIG. 2 is a perspective view of three LGPs assembled into a three-dimensional structure;

FIG. 3 is a front elevational view of a system of four LGPs connected together in a series, illustrating power being brought into the system at two different points;

FIG. 4 is a cross-sectional view of an LGP frame, illustrating an alternative, internal structure for making an electrical connection with a magnet mounted on the exterior of the frame;

FIG. 5 illustrates an LGP frame with a grouped set of contacts for making connections between a power cable with multiple conductors and a number of individual magnets arrayed along the side of the frame;

FIG. 6 is an illustration of another LGP frame that uses a terminal block to make connections between a power cable with multiple conductors and a number of individual magnets arrayed along the side of the frame; and

FIG. 7 is a partial top plan cross-section of an LGP according to another embodiment, showing magnets inlaid in notches in the light guide.

### DETAILED DESCRIPTION

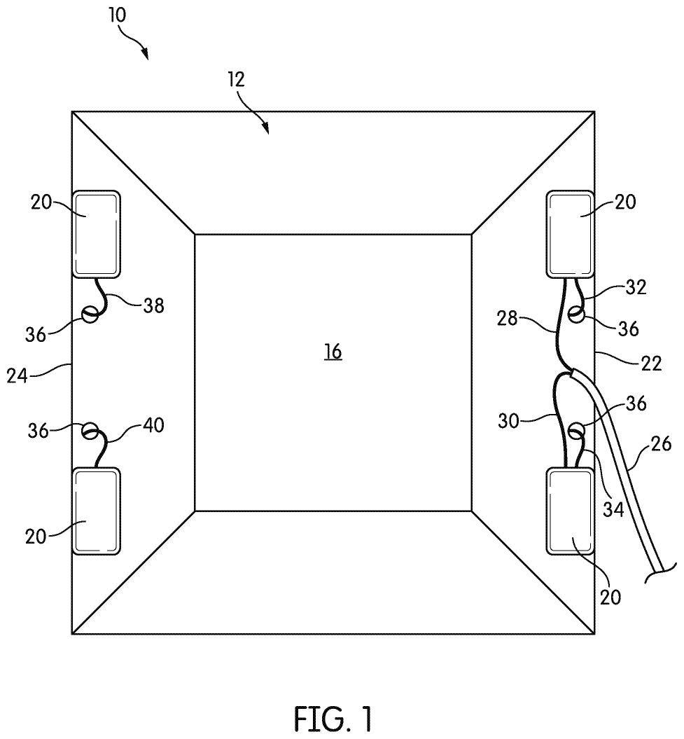

FIG. 1 is a plan view of the reverse side a light-guide panel (LGP), generally indicated at 10, according to one embodiment of the invention. The LGP 10 includes a frame 12, a light guide 14 (not shown in FIG. 1), and a reflective layer 16, which backs the light guide 14 and obscures it in the view of FIG. 1.

The light guide 14 is typically a sheet of plastic, such as polymethyl methacrylate (PMMA) or polycarbonate, but other plastics may be used. Additionally, glass may be used in some embodiments, as may more exotic materials like sapphire. The only typical requirement of a light guide 14 is that it have a higher index of refraction than its surrounding environment. For example, if the LGP 10 is to be used in air, the light guide 14 should have an index of refraction higher than that of air. A typical light guide 14 intended for use in air has a refractive index of at least about 1.4, although materials with higher indices of refraction may be used.

The LGP 10 may be assumed to have at least one strip of linear lighting, mounted within the frame 12, that emits light into the edge of the light guide 14. However, in various embodiments, all sides of the frame 12 may have such strips of linear lighting. The number of strips of linear lighting that are used, and their positioning, may be determined by a number of factors, including the size of the LGP 10, the luminous flux required of the LGP 10, and the degree of evenness of light emission that is required across the surface of the LGP 10. In the illustrated embodiment, it may be assumed that there are two strips of linear lighting, positioned along the left and right sides of the frame 12, although more or fewer may be used. The number of strips of linear lighting that is used is not critical to the invention.

As described above, the front surface of the light guide 14 may have a texture or pattern to facilitate light release. This pattern may be formed, e.g., by laser etching.

The LGP 10 of this embodiment is square, although the LGP 10 may have any shape, including other polygonal shapes and curved shapes. Rectangular shapes are the most common for LGPs 10, and if a rectangular shape is used, it may have any height-to-width aspect ratio desired. Other polygonal shapes might include, e.g., triangles, circles, and hexagons.

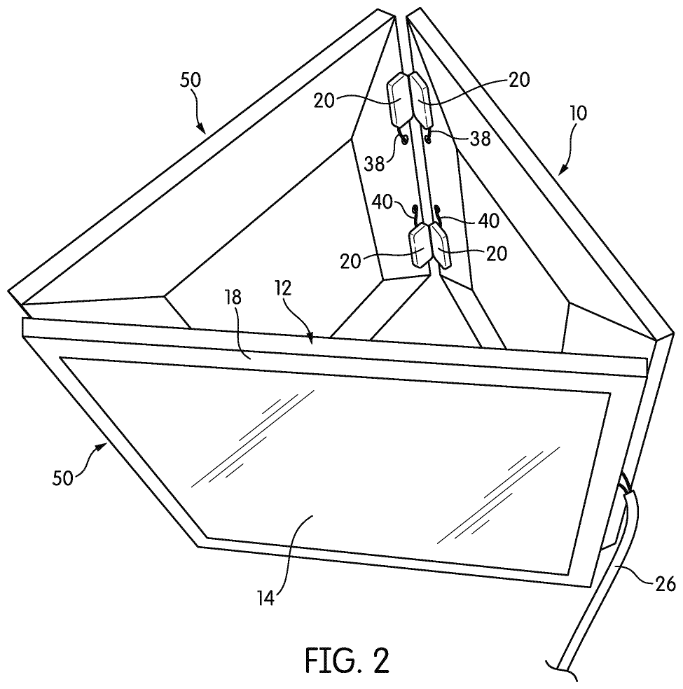

The frame 12 of the LGP 10 is mitered in the corners. As can be seen in the perspective view of FIG. 2, the frame 12 forms a thin rim 18 around the front of the light guide 14, but covers a significant portion of the rear of the LGP 10. The primary purpose of the frame 12 is to mount the linear lighting in place and to make a light-tight seal around the light guide 14. Any shape or extent for the frame 12 that accomplishes those goals may be used. The frame 12 may also mount and protect, or at least partially protect, any reflective layer(s) 16 placed behind the light guide 14.

In the illustrated embodiment, the LGP 10 and its light guide 14 are generally flat, although there is no requirement that they be so in all embodiments. LGPs and light guides according to embodiments of the invention may be curved in multiple planes.

LGP 10 differs from conventional LGPs in the manner in its handling of power, and in the way in which it is adapted to connect to other LGPs. As shown, LGP 10 has four magnets 20 positioned immediately proximate to its side edges 22, 24. The magnets 20 may be flush with their respective edges 22, 24, or they may be set back from the edges a short distance, e.g. 1-5 mm. The magnets 20 may be adhered to the frame 12 solely by way of magnetic attractive force, or they may be secured to the frame 12 by any suitable means, including fasteners and adhesives. The magnets 20 are adapted to serve as both mechanical connectors (i.e., by way of magnetic attractive force) to connect the LGP 10 to other LGPs and as terminals to receive and convey power.

The magnets 20 themselves may be any type of permanent magnet, including aluminum-nickel-cobalt, strontium-iron, neodymium-iron-boron, samarium-cobalt, or the like. If the magnet 20 itself is not electrically conductive, it may be coated with any conductive material, including nickel, zinc, and multi-layer conductive coatings with other metals and materials, including Ni—Cu—Ni and Ni—Cu—Au, to name a few. In one embodiment, the magnets may be nickel or multi-layer nickel-plated neodymium magnets.

In the illustration of FIG. 1, two magnets 20 are on each side 22, 24 of the frame 12 of the LGP 10, spaced from one another about evenly along the length of the side 22, 24. The two magnets 20 on a single side 22, 24 are electrically isolated from one another. In this embodiment, the two magnets 20 that are directly across from one another are electrically coupled to one another, as will be explained below in more detail.

On the left side 22 of the LGP 10, a power cable 26 is shown. In this embodiment, the power cable 26 has two conductors, a positive conductor 28 and a negative or minus-return conductor 30. The positive conductor 28 is connected to one magnet 20, in this case, the upper magnet 20, and the minus-return conductor 30 is connected to the other magnet 20, in this case, the lower magnet 20. The connections between the conductors 28, 30 and their respective magnets 20 may be made by soldering, by adhesive (e.g., conductive adhesive) or by other mechanisms, as will be described below in more detail.

In each case, a second wire 32, 34 is electrically connected at one end to a magnet 20. The second wires 32, 34 transit through openings 36 in the frame 12 to connect to linear lighting within the frame 12. Thus, in this embodiment, the magnets 20 act as connection terminals, receiving power from the cable 26 and its conductors 28, 30 and serving as connection points for second wires 32, 34 that penetrate the frame 12 to bring power to the linear lighting within its interior. As was described briefly above, in this embodiment, the power is low voltage DC power.

On the opposite side of the LGP 10, a second set of magnets 20 receive power from third wires 38, 40 that exit the frame 12 through openings 36 and connect to respective magnets 20. With the arrangement shown in FIG. 1, both sets of magnets 20, on the right side 22 and the left side 24, will convey power to adjacent LGPs 20 if and when complementary magnets or magnetic, conductive pieces make contact.

In the view of FIG. 1, there is one opening 36 for each magnet 20. In some embodiments, there may be fewer openings 36. For example, a single opening 36 may be provided in the center of each side of the LGP 10, with longer lead wires that contact each magnet 20 on that side. The use of fewer openings 36 provides less chance for light leaking out and less chance for contamination getting in. It could also mean fewer manufacturing steps to seal the openings 36 around the wires.

Within the frame 12 of the LGP 10, various arrangements may be used. For example, a magnet 20 on the right side 22 may be directly connected to its counterpart magnet 20 on the left side 24 by a dedicated wire or conductor within the frame 12. Alternately, connections between counterpart magnet-terminals 20 may be indirect and made through other electrical components. For example, one magnet 20 may connect to a terminal on a strip of linear lighting, which connects to another strip of linear lighting, which connects to the counterpart magnet on the opposite side.

One possible application of this is shown in FIG. 2, which shows three LGPs connected in a shape that approximates a triangular prism. One LGP 10 is the LGP of FIG. 1. The other two LGPs 50 have magnets 20 on their side edges, just as the LGP 10 does, and those magnets 20 are electrically connected as power terminals, but they are not connected to a power cable 26. In the arrangement shown in FIG. 2, all three LGPs 10, 50 are lit when the power cable 26 is connected to power. The LGPs 50 that are not directly connected to a power cable 26 receive power through the magnets 20 which, as described above, serve as power terminals. This arrangement allows multiple LGPs 10, 50 to be assembled into numerous configurations, some of which are self-supporting, with only limited connection to power. Examples include pyramids, cubes, etc.

There is no particular limit to the number of LGPs 10, 50 that can be connected and powered in this way. However, regulatory limits in some jurisdictions may impose limits on the total amount of power that a system comprised of multiple LGPs 10, 50 can draw and the maximum voltage that may be used. For example, Class 2 low voltage standards promulgated in the National Electrical Code by the National Fire Protection Association in the United States limit low-voltage circuits to 60 W of power at 12V and 96 W of power at 24V. Additionally, as a practical matter, if a number of LGPs 10, 50 are in series, Ohmic voltage drop, i.e., loss of voltage due to the inherent electrical resistance of the magnets 20 and other electrical components of the circuit, may limit the number of LGPs 10, 50 that can be connected together and successfully lit. If a particularly large number of LGPs 10, 50 is to be connected together, it may be useful to connect corresponding magnets 20 together directly by dedicated conductors, rather than routing the connection through strips of linear lighting or other electrical components.

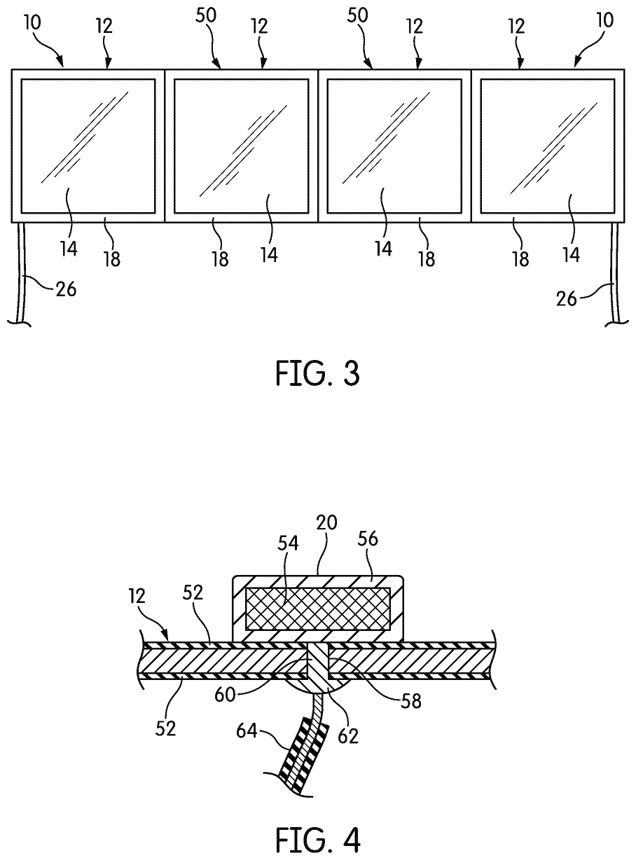

In some embodiments, more than one LGP 10 in a connected a connected system may be connected to a power cable 26 to bring power into the system. FIG. 3 is a front elevational view of four LGPs 10, 50 arranged in a simple series. This arrangement is chosen for ease of illustration and description, but the arrangement could be of any type. In the system of FIG. 3, two LGPs 10 with power cables 26 are at respective ends of the series, and two LGPs 50 without connection to power cables 26 lie between them. As was described above, bringing power in at multiple points may increase the number of LGPs 10, 50 that can be connected in any one series.

It should also be understood that although the LGPs 10, 50 have terminal-magnets 20 along two sides 22, 24, an LGP according to embodiments of the invention may have terminal-magnets 20 on any number of sides. If terminal-magnets 20 are provided along three or four sides of the LGP 10, 50, those additional terminal-magnets 20 increase the number of ways that a single LGP 10, 50 can be connected to others, and thus, increase the versatility of lighting systems that can be built using the LGPs 10, 50. On the other hand, terminal-magnets 20 along only one side of the LGP 10, 50 may be sufficient in some embodiments.

Moreover, LGPs according to embodiments of the invention may have some magnets that do not act as terminals. As may be apparent from the description above, in a simple embodiment, only two magnets 20 need act as terminals in a scenario where the LGP 10, 50 requires only one channel of low-voltage DC power to operate. However, additional magnets may be provided that do not act as terminals and are serve solely to increase attachment force. Magnets 20 that act as terminals may also be of substantial size in some cases, so that they cover a substantial portion of each connecting side 22, 24.

In the above description, wires 32, 34, 38, 40 soldered to the magnets 20 are used to convey power. However, there are arrangements that may reduce or eliminate the need to use wires 32, 34, 38, 40, at least externally. FIG. 4 is a cross-sectional view of a portion of the frame 12 illustrating an alternative way in which the magnet 20 may be connected.

More specifically, in this view, a magnet 20 rests atop the frame 12, just as described above. The frame 12 has a nonconducting layer 52 as its outer surface, and a similar nonconducting layer 52 on its inner surface. That nonconducting layer 52 may be paint, another type of coating, an oxide layer, or any other kind of insulative or passivating layer that may be used. The magnet 20 itself has a core 54 of magnetic material and, as described above, an outer conductive layer 56. A through-hole 58 is formed in the frame 12 directly underneath the magnet 20. That through-hole 58 is filled with solder or another conductive compound 60 and forms a terminal or pad 62 along the interior of the frame 12. An interior wire 64 is connected to the pad 62, e.g., by soldering, and carries power from the magnet 20 to the linear lighting and other components within the frame 12.

The conductors 28, 30 from the power cable 28 may enter the frame 12 and make internal connections in similar fashion. Alternatively, a specific connector for the power cable 26 and its conductors 28, 30 may be provided along the exterior of the frame 12.

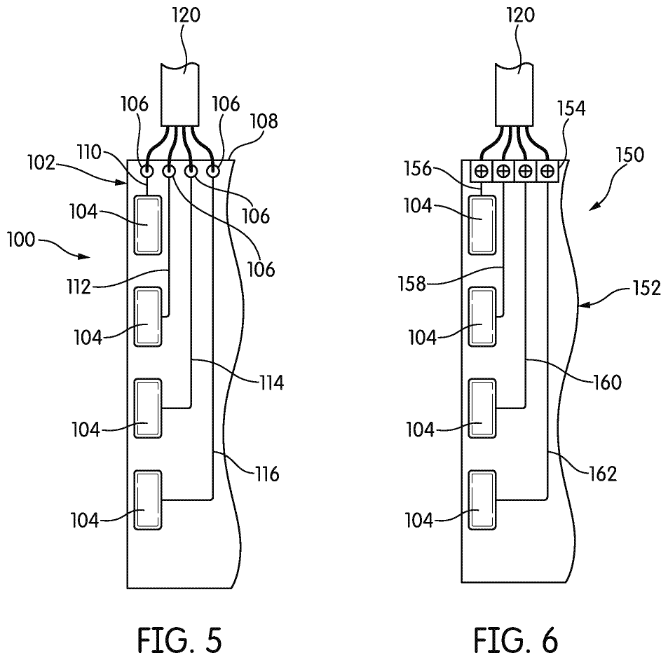

Although LGPs 10, 50 above use two-terminal connections to convey power, there are situations in which more terminals may be needed to convey power and, in some cases, data signals. FIG. 5 is a schematic illustration of a portion of an LGP, generally indicated at 100, illustrating this principle. Specifically, a portion of the frame 102 of the LGP 100 is shown.

One common situation in which more terminals and conductors may be needed occurs when the LED light engines on a strip of linear lighting are capable of emitting more than one color of light. In this case, the LED light engines would typically contain more than one type of LED, each of which requires its own power and control signals. For example, so-called RGB LED light engines contain independently-controllable red, green, and blue LEDs which are additively color-mixed to produce any number of different colors of light. This may also be the case if the LED light engines are designed to produce multiple, different colors of so-called “white” light. A full survey of all scenarios in which LED light engines may require more than positive and minus-return conductors 28, 30 lies outside the scope of this document, but there are many.

The illustration of FIG. 5 assumes that the LGP 100 has RGB LEDs, which require a separate (voltage) control signal for each of the red, green, and blue channels, as well as a common anode or cathode, for a total of four voltage/signal lines. Thus, there are four magnets 104 arrayed along the edge of the frame 102. With the magnets 104 spread out over the length of the side of the frame 102, connecting the conductors of a power cable individually to each magnet 104 may be impractical. Thus, the LGP 100 also has another feature: a set of four conductive contacts 106 clustered together along the perpendicular edge 108 of the frame 102. These contacts 106 are connected by pre-laid conductors 110, 112, 114, 116 to respective magnets 104. These pre-laid conductors 110, 112, 114, 116 may be inlaid wires, conductors on a printed circuit board that is laid on the frame, or any other suitable type of connectors. This simplifies and neatens the process of connecting magnets 104 with a power cable 120.

The contacts 106 of FIG. 5 may be simple solder pads, but more complex arrangements may be used. For example, FIG. 6 is an illustration of an LGP 150 with a frame 152. The arrangement of the frame 152 is very similar to that of the frame 102 of FIG. 5. There are four magnets 104 arrayed along the outer edge of the frame. In this case, a terminal block 154 with four individual terminals receives the conductors from the power cable 120. Individual conductors 156, 158, 160, 162 are connected between the terminal block 154 and the magnets 104. Although these conductors 156, 158, 160, 162 are shown as being on the external surface of the frame 152 for ease of illustration, they may alternatively be on the inside surface of the frame 152 and use structures such as those shown in FIG. 4 to make electrical connections with the magnets 104.

Of course, a terminal block 154 is only one example of a connecting structure that may be used for a power cable 120. In other embodiments, complementary male and female connectors on the power cable and frame may be used to make press-in connections that are easily made and, when needed, easily broken.

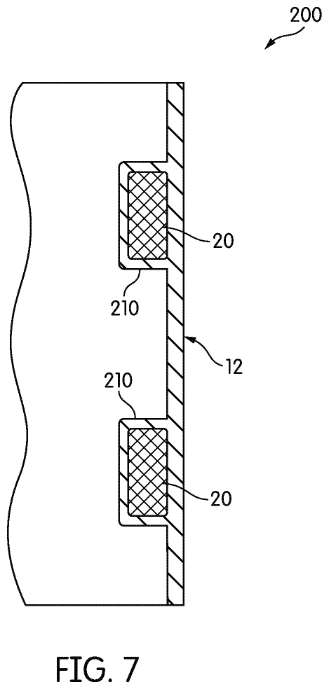

In all of the above description, the magnets 20 are shown as lying along the exterior of the LGP 10, 50. However, that need not be the case in all embodiments. In some embodiments, the magnets 20 may be inlaid into the frame 12 or into the light guide 14 itself. FIG. 7 is a partial cross-sectional view of an LGP 200 according to another embodiment of the invention. In FIG. 7, magnets 20 are inlaid into notches 210 cut in the light guide.

One particular advantage of embodiments of the invention is that additional LGPs 10, 50 may be added on to a system simply by bringing them in close enough proximity to snap into place by magnetic attraction. Because magnets provide both electrical and mechanical connection, LGP lighting systems can be quickly and dynamically assembled and disassembled, and an assembled system may be either temporary or permanent. For example, a number of LGPs 10, 50 may be assembled to provide light over an area and that area may be added to quickly by snapping additional LGPs 10, 50 in place if expansion is necessary. As shown in FIG. 2, quickly-assembled self-supporting structures may provide localized task lighting or even aesthetic light sculpture.

Although much of this description shows and describes magnets 20, 104 as the sole connecting structure that connects adjacent LGPs 10, 50, that need not be the case in all embodiments. Particularly with larger or heavier LGPs 10, 50 magnetic force may not be sufficient to secure two LGPs 10, 50 together. In that case, or if a structure made with LGPs 10, 50 is intended to be semi-permanent or permanent, additional mechanical securement may be used. This may include screws, bolts, nails, staples, etc., and LGPs 10, 50 according to embodiments of the invention may include flanges, openings, straps, and other structures to receive fasteners. As those of skill in the art will note, even if an LGP-based structure requires additional securement, the magnets 20, 104 may still provide some advantages in the construction of such structures: they may provide enough force to bind adjacent LGPs 10, 50 together while additional mechanical securement is installed, or they may allow the temporary construction of a structure while the need for additional mechanical securement is evaluated.

It should also be understood that while this description focuses on traditional LGPs powered by traditional linear lighting, the connection techniques and resulting systems described here may be applied to other types of technologies. For example, the light source within the LGPs 10, 50 need not be traditional LED linear lighting, but may instead be continuous strips of organic light emitting diodes (OLEDs) or other light-emitting technologies. In fact, in some cases, the light-emitting panel may be a large OLED panel. When the term “LGP” is used in this description, unless the text indicates otherwise (e.g., by referring to structure that is only found in an LGP per se), the term should be interpreted to refer to all types of light-emitting panels.

As those of skill in the art will understand, the LGPs 10, 50, 100, 150, 200 described above are all of the “fixed frame” variety, i.e., the frame is fixed in place. LGPs are also made in so-called “snap frame” configurations. In a snap-frame LGP, a portion of the frame is movable and can “snap” into place. LGPs of this type are most commonly used as backings for advertisements. The medium holding the advertisement is clamped into place by the frame of the LGP and also backlit by it. Snap-frame LGPs are particularly convenient when backlit advertisements may need to be changed often. The structures described above may be applied to snap-frame LGPs as well.

This description uses the term “about.” When that term is used in this description, it means that the stated value or range of values may change as long as those changes do not make the stated function or result impossible. If it cannot be determined what amount of change would make a stated function or result impossible, the term “about” to should be construed to mean±5%.

While the invention has been described with respect to certain embodiments, the description is intended to be exemplary, rather than limiting. Modifications and changes may be made within the scope of the invention, which is defined by the appended claims.

What is claimed is:

1. A light-emitting panel, comprising:
a light-emitting element;
a frame around the light-emitting element; and
one or more magnets provided on or along at least one portion of the frame, the one or more magnets being electrically connected to the light-emitting element to provide both mechanical connection to structures adjacent to the frame and electrical power to the light-emitting element.

2. The light-emitting panel of claim 1, wherein:
the light-emitting element comprises a light-guide panel (LGP); and
the light-emitting element includes a light guide and one or more strips of LED linear lighting arranged to emit light into a first portion of the light guide, the light guide being adapted to emit light from a second portion different from the first portion.

3. The light-emitting panel of claim 2, wherein the light guide comprises a sheet of plastic or glass.

4. The light-emitting panel of claim 3, wherein the plastic comprises polymethyl methacrylate or polycarbonate.

5. The light-emitting panel of claim 2, wherein the at least one portion of the frame comprises at least one edge of the frame.

6. A light-guide panel, comprising:
a light guide having a light-accepting surface and a light-emitting surface distinct from the light-accepting surface;
a light source arranged to emit light into the light-accepting surface such that the light is emitted from the light guide along the light-emitting surface;
a frame surrounding at least the light source;
two or more magnets electrically connected to the light source and arranged in relation to the frame so as to provide mechanical connecting force for the light-guide panel.

7. The light-guide panel of claim 6, wherein the two or more magnets are disposed on the exterior of the light-guide panel.

8. The light-guide panel of claim 6, wherein the two or more magnets lie within the light-guide panel.

9. The light-guide panel of claim 6, wherein the light guide includes two or more notches along an edge thereof and the two or more magnets are set within the two or more notches.

10. The light-guide panel of claim 9, wherein the frame surrounds the notches.

11. The light-guide panel of claim 6, wherein the light source comprises a strip of linear lighting.

12. An assembly, comprising:
a first light-guide panel including
a first light guide having a first light-accepting surface and a first light-emitting surface distinct from the first light-accepting surface,
a first light source arranged to emit first light into the first light-accepting surface such that the first light is emitted from the first light guide along the first light-emitting surface,
a first frame surrounding at least the first light source, and
two or more first magnets electrically connected to the light source and arranged in relation to the frame; and
a second light-guide panel including
a second light guide having a second light-accepting surface and a second light-emitting surface distinct from the second light-accepting surface,
a second light source arranged to emit second light into the second light-accepting surface such that the second light is emitted from the second light guide along the second light-emitting surface,
a second frame surrounding at least the first light source, and
two or more second magnets electrically connected to the second light source and arranged in relation to the second frame;
wherein the two or more first magnets and the two or more second magnets are magnetically attracted to one another and in contact with one another to provide mechanical and electrical connection between the first light-guide panel and the second light-guide panel.
